(19) United States
(12) Patent Application Publication
(10) Pub. No.: US 2026/0348861 A1
(43) Pub. Date: Nov. 5, 2026

(54) RESPONSIVE AEROGEL AND APPLICATION THEREOF

(71) Applicant: Zhejiang University, Hangzhou (CN)

(72) Inventors: Yingchun FU, Hangzhou (CN); Shugang YAN, Hangzhou (CN); Yuxin SUN, Hangzhou (CN)

(21) Appl. No.: 19/530,420

(22) Filed: Feb. 5, 2026

Related U.S. Application Data
(63) Continuation of application No. PCT/CN2025/148148, filed on Dec. 31, 2025.

(30) Foreign Application Priority Data
Apr. 30, 2025 (CN) 2025105662849

(51) Int. Cl. G01N 21/78; C08G 65/332; C08J 3/02; C08J 9/00; C08K 5/372; C08K 5/56

(52) U.S. Cl. CPC G01N 21/783; C08G 65/3322; C08J 3/02; C08J 9/0095; C08K 5/372; C08K 5/56; C08J 2207/00; C08J 2371/02; C08J 2389/00

(57) ABSTRACT

A responsive aerogel and an application thereof are provided, which relate to the field of gas detection technologies. The responsive aerogel is prepared by the following steps: mixing a metal organic framework with lead acetate to obtain an integrated adsorption-response probe; and mixing silk fibroin, polyethylene glycol diacrylate, and the integrated adsorption-response probe, and performing a photo-curing reaction on the mixed solution under an action of a photo-crosslinking agent to obtain the responsive aerogel. A double-network aerogel substrate formed by reaction of silk fibroin and polyethylene glycol diacrylate can adsorb water molecules from environments with different humidity levels, causing substrate wetting and providing a saturated microscopic aqueous environment for colorimetric reaction on pore wall surfaces, thereby effectively mitigating interference of environmental humidity with the response. The quantification method established using the responsive aerogel can be used for highly sensitive quantitative detection of hydrogen sulfide in livestock and poultry farms.

### TECHNICAL FIELD

The disclosure relates to the field of gas detection technologies, and more particularly to a responsive aerogel and an application thereof.

### BACKGROUND

With the large-scale and intensive development of China's livestock and poultry breeding industry, the harmful gases produced pose risks to animal and human health and pollute the ecological environment, which becomes a key factor restricting the industry's development. Current gas detection technologies, such as gas chromatography-mass spectrometry, spectrophotometry, and laser absorption spectroscopy, can provide accurate detection but suffer from cumbersome operation, high cost, and lengthy analysis cycles, making them difficult to deploy for on-site use in production settings. Gas sensors based on metal semiconductors, while small and portable, require high operating temperatures, consume significant energy, and exhibit poor selectivity and stability, which limit their large-scale, long-term application. Colorimetric sensors based on various chemical responsive dyes have become a research hotspot in the field of hazardous gas detection due to their simple design, low cost, and good selectivity. However, most of these chemical dyes are acid-base indicators or redox dyes, making it difficult to achieve specific gas detection. Furthermore, the aggregation of dyes limits gas transport efficiency, thereby hindering highly sensitive detection. Additionally, the challenging breeding environment, characterized by high levels of interference, high humidity, and significant humidity fluctuations, poses further challenges for the development and application of colorimetric sensors.

### SUMMARY

In order to solve the above technical problems, the disclosure proposes a responsive aerogel. A colorimetric sensing method for hydrogen sulfide established based on the responsive aerogel can be directly used for highly sensitive enrichment and detection of hydrogen sulfide gas, and is capable of overcoming influence of different humidity levels in the detection environment.

Technical solutions adopted by the disclosure are as follows.

A first aspect of the disclosure provides a responsive aerogel, which is prepared by the following steps:
mixing and dissolving a metal organic framework with lead acetate to obtain an integrated adsorption-response probe; and
mixing silk fibroin, polyethylene glycol diacrylate, and the integrated adsorption-response probe to obtain a mixed solution, and performing a photo-curing reaction on the mixed solution under an action of a photo-crosslinking agent to obtain the responsive aerogel.

The silk fibroin is used as a skeleton, which has a three-dimensional porous structure. A double-network aerogel substrate formed by interweaving with polyethylene glycol can adsorb water molecules from the environment, which provides a saturated microscopic aqueous environment for a colorimetric reaction on pore wall surfaces, thereby effectively mitigating interference of environmental humidity with the response.

In an embodiment of the disclosure, in the mixed solution, a concentration of the silk fibroin is in a range of 10 milligrams per milliliter (mg/mL) to 40 mg/mL, a volume fraction of the polyethylene glycol diacrylate is in a range of 1/64 to ⅛, a concentration of the lead acetate is in a range of 25 mg/mL to 200 mg/mL, and a concentration of the metal-organic framework is in a range of 3.25 mg/mL to 15 mg/mL.

In an embodiment, in the mixed solution, the concentration of the silk fibroin is 20 mg/mL, the volume fraction of the polyethylene glycol diacrylate is 1/32, the concentration of the lead acetate is 50 mg/mL, and the concentration of the metal-organic framework is 7.5 mg/mL.

In an embodiment of the disclosure, the photo-curing reaction is performed under simultaneous irradiation at 365 nanometers (nm) and 405 nm for at least 3 minutes (min).

In an embodiment of the disclosure, the photo-crosslinking agent is potassium persulfate, photoinitiator 1173 (also referred as 2-hydroxy-2-methylpropiophenone), and tris(2,2′-bipyridine)dichlororuthenium(II) hexahydrate ([Ru(bpy)₃]Cl₂).

In an embodiment of the disclosure, the metal-organic framework is prepared by the following steps:
mixing aluminum salt, 2,5-thiophenedicarboxylic acid and N,N-dimethylformamide for reaction to obtain the metal-organic framework.

A second aspect of the disclosure provides an application method of the responsive aerogel, including: detecting hydrogen sulfide gas by using the responsive aerogel.

A third aspect of the disclosure provides a method for detecting hydrogen sulfide gas by using the responsive aerogel, including:
filtering hydrogen sulfide gas to be detected by using the responsive aerogel, measuring a Euclidean distance of color change of the responsive aerogel under an action of the hydrogen sulfide gas, and calculating a concentration of the hydrogen sulfide gas by combining with a pre-calibrated curve.

In an embodiment of the disclosure, the measuring a Euclidean distance of color change of the responsive aerogel under an action of the hydrogen sulfide gas specifically includes:
acquiring a color image of the responsive aerogel in a sealed environment with constant illumination;
extracting mean values of three color channels for a region of the responsive aerogel in the color image; and
calculating the Euclidean distance of the mean values of the three color channels of the responsive aerogel before and after reaction between the responsive aerogel and the hydrogen sulfide gas.

In an embodiment of the disclosure, a calculation formula of the Euclidean distance is expressed as follows:

ED=\sqrt{(R−R₀)²+(G−G₀)²+(B−B₀)²}
where R, G and B respectively represent the mean values of the three color channels of the responsive aerogel after the filtering, and R₀, G₀ and B₀ respectively represent the mean values of the three color channels of the responsive aerogel before the filtering.

In an embodiment of the disclosure, the pre-calibrated curve is a relational curve established by fitting color change values with corresponding hydrogen sulfide concentrations, and the color change values are obtained by repeatedly conducting the same experiment with different predetermined concentrations of hydrogen sulfide.

A fourth aspect of the disclosure provides a sensor for detecting hydrogen sulfide gas, including the responsive aerogel.

The responsive aerogel prepared in the disclosure has the following advantages.

In the disclosure, a double-network aerogel substrate is first prepared by using the silk fibroin and the polyethylene glycol diacrylate as raw materials with the addition of the photo-crosslinking agent. Herein, the silk fibroin reacts and solidifies under light with the potassium persulfate, thereby forming a three-dimensional porous aerogel after drying. The polyethylene glycol diacrylate solidifies under light with photoinitiator 1173 to form a polyethylene glycol gel. The silk fibroin and the polyethylene glycol gel interweave and cure to form a double-network gel. The silk fibroin network serves as a supporting skeleton of the aerogel, while the incorporation of the polyethylene glycol network significantly enhances its hydrophilicity. By adsorbing water molecules from the environment, it provides a microscopic aqueous environment for the colorimetric reaction, thereby eliminating the influence of varying humidity.

In the disclosure, the metal organic framework can adsorb hydrogen sulfide gas and lead ions. Lead acetate is used as the colorimetric probe, which can react with the hydrogen sulfide gas under moist conditions to form lead sulfide, thereby causing the color to change from white to black. The mixture of the metal organic framework and the lead acetate integrates the functions of colorimetric probe adsorption and target gas adsorption, thereby constructing an integrated adsorption-response probe. This greatly enhances the binding efficiency between gas molecules and the colorimetric probe, thereby achieving highly sensitive enrichment detection of hydrogen sulfide gas.

The silk fibroin-polyethylene glycol aerogel, i.e., the double-network aerogel substrate formed from the silk fibroin and the polyethylene glycol diacrylate (hereinafter referred to as silk fibroin-polyethylene glycol (SF-PEG) aerogel) prepared in the disclosure, possesses a primary microporous structure. The integrated adsorption-response probe has a secondary nanoporous structure. The responsive aerogel obtained by mixing these not only retains the three-dimensional porous structure of the silk fibroin-polyethylene glycol aerogel but also distributes the integrated response probe on its pore wall surfaces, so that the responsive aerogel has a hierarchical porous structure, which effectively improves the mass transfer of gas molecules within it while increasing the loading capacity of the colorimetric probe.

The disclosure utilizes the responsive aerogel to establish a colorimetric quantification method based on color difference values from digital images, thereby solving the problem of inaccurate quantification in colorimetric sensing.

In summary, addressing the issues of low sensitivity and humidity interference in colorimetric detection technologies in the related art, the disclosure develops a hydrophilic responsive aerogel with a hierarchical porous structure for the stable and highly sensitive detection of hydrogen sulfide.

The responsive aerogel is a hierarchically porous composite material based on a silk fibroin (SF)-polyethylene glycol diacrylate (PEGDA) double-network skeleton, loaded with the MIL-53@Pb composite functional material. Its core structural characteristics are as follows: a three-dimensional porous SF skeleton formed by photo-crosslinking serves as the support, with a PEGDA polymer network interpenetrating it to enhance hydrophilicity and mechanical toughness, thereby constructing the double-network substrate. On this substrate, the MIL-53@Pb composite formed by the metal-organic framework MIL-53 adsorbing the lead acetate (Pb(Ac)₂) probe is uniformly loaded via a one-pot method. This creates a unique “micron-nano” hierarchically porous structure. The SF-PEGDA aerogel itself provides micrometer-scale porous channels, while the MIL-53 particles attached to its surface contribute nanometer-scale pores and a high specific surface area. This aerogel does not possess a single chemical formula but is rather a functional composite of the aforementioned multiple components. Its structural design also incorporates a microscopic aqueous environment maintained by the hydrophilic PEGDA network. These structural features work synergistically to collectively endow the aerogel with efficient gas adsorption and transport capabilities, highly loaded and uniformly dispersed active probe sites, and a stable reaction microenvironment. This enables highly sensitive and humidity-interference-resistant colorimetric detection of H₂S gas.

### BRIEF DESCRIPTION OF DRAWINGS

FIG. 1 illustrates a schematic diagram of a preparation principle of a responsive aerogel according to the disclosure.

FIG. 2A illustrates a scanning electron microscope (SEM) image of a silk fibroin aerogel prepared by a silk fibroin with a mass fraction of 0.5%.

FIG. 2B illustrates a SEM image of a silk fibroin aerogel prepared by a silk fibroin with a mass fraction of 1%.

FIG. 2C illustrates a SEM image of a silk fibroin aerogel prepared by a silk fibroin with a mass fraction of 2%.

FIG. 2D illustrates a SEM image of a silk fibroin aerogel prepared by a silk fibroin with a mass fraction of 4%.

FIG. 2E illustrates a SEM image of a silk fibroin aerogel prepared by [Ru(bpy)₃]Cl₂ with a concentration of 0.01 micromoles per liter (μM).

FIG. 2F illustrates a SEM image of a polyethylene glycol aerogel.

FIG. 3A illustrates physical images of silk fibroin-polyethylene glycol aerogels with different concentrations of silk fibroin and polyethylene glycol diacrylate.

FIG. 3B illustrates SEM images of silk fibroin-polyethylene glycol aerogels with a 2 weight percentages (wt %) silk fibroin and different concentrations of polyethylene glycol diacrylate.

FIG. 3C illustrates a Fourier transform infrared (FTIR) spectrum of the silk fibroin, the polyethylene glycol diacrylate and the silk fibroin-polyethylene glycol aerogel.

FIG. 3D illustrates a schematic diagram of water absorption capacity of silk fibroin-polyethylene glycol aerogels with different contents of the polyethylene glycol diacrylate.

FIG. 3E illustrates physical images of a silk fibroin-polyethylene glycol aerogel elastomer; in which I, II, III, and IV correspond to volume fractions of the polyethylene glycol diacrylate in a mixed system during preparation of 0, 1/64, 1/32, and 1/16, respectively.

FIG. 4A illustrates SEM images of a metal organic framework MIL-53.

FIG. 4B illustrates SEM images of a lead-loaded MIL-53.

FIG. 4C illustrates a SEM image of the lead-loaded MIL-53 and energy dispersive x-ray spectroscopy (EDS) mappings of aluminum (Al), lead (Pb), and sulfur (S).

FIG. 4D illustrates SEM images of the responsive aerogel.

FIG. 4E illustrates a FTIR spectrum of the responsive aerogel.

FIG. 4F illustrates an X-ray diffraction (XRD) pattern of the responsive aerogel.

FIG. 4G illustrates a schematic diagram of nitrogen adsorption-desorption isotherms of the MIL-53 and the lead-loaded MIL-53.

FIG. 5A illustrates a schematic diagram of a transmission principle of hydrogen sulfide gas.

FIG. 5B illustrates a schematic diagram of adsorption of hydrogen sulfide by the MIL-53.

FIG. 5C illustrates a schematic diagram of water adsorption by a polyethylene glycol diacrylate (PEGDA) layer.

FIG. 5D illustrates a schematic diagram of response differences of aerogels with different internal structures.

FIG. 5E illustrates a schematic diagram of response of responsive aerogels with different contents of the MIL-53 to the hydrogen sulfide.

FIG. 5F illustrates a schematic diagram of effects of contents of the polyethylene glycol diacrylate on the response.

FIG. 5G illustrates a schematic diagram of optimization of a response time.

FIG. 5H illustrates a schematic diagram of gradient response of the responsive aerogel.

FIG. 5I illustrates a schematic diagram of selectivity of the responsive aerogel.

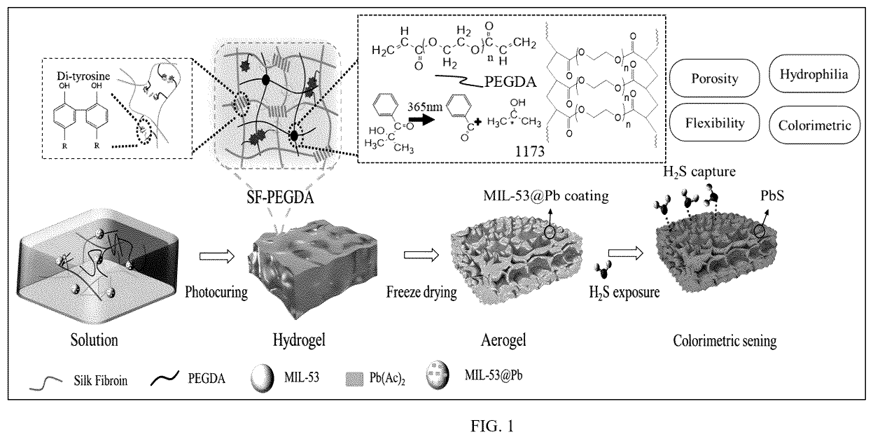

### DETAILED DESCRIPTION OF EMBODIMENTS

In order to enable those skilled in the art to better understand technical solutions of the disclosure, the method provided by the disclosure will be described in detail below in conjunction with drawings and embodiments. The following embodiments are only used to illustrate the disclosure and not to limit a scope of the disclosure.

The disclosure provides a responsive aerogel (silk fibroin-polyethylene glycol diacrylate-metal organic framework with lead acetate, abbreviated as SF-PEGDA-MIL-53@Pb). The responsive aerogel uses a silk fibroin-polyethylene glycol (SF-PEGDA) double-network aerogel as a three-dimensional porous substrate, and incorporates an efficient adsorbent MIL-53 (a type of metal-organic framework) loaded with hydrogen sulfide (H₂S), to construct a hierarchical porous structure, which facilitates transport and adsorption enrichment of H₂S molecules. The SF-PEGDA-MIL-53@Pb aerogel relies on a classical reaction between lead acetate (Pb(Ac)₂) and H₂S to achieve color change output. Since MIL-53 also exhibits good adsorption performance for Pb(Ac)₂, a highly sensitive detection strategy integrating adsorption, enrichment, and response is realized. The SF-PEGDA double-network aerogel designed and prepared in the disclosure can adsorb water molecules from environments with different humidity levels, which wets the substrate and provides a saturated microscopic aqueous environment for the colorimetric reaction on the pore wall surfaces, thereby effectively mitigating interference of environmental humidity with the response. Furthermore, to address a problem of inaccurate quantification in colorimetric sensing, the disclosure utilizes the SF-PEGDA-MIL-53@Pb aerogel to establish a colorimetric quantification method based on color difference values from digital images. This method can be used for highly sensitive quantitative detection of hydrogen sulfide in livestock and poultry farms, thereby providing solutions and technical support for the highly sensitive, low-cost, on-site detection of gases in breeding environments.

### Embodiment 1

A responsive aerogel is prepared by the following steps.
(1) An integrated adsorption-response probe is synthetized.

In step 1, 1800 milligrams (mg) of aluminum nitrate (nonahydrate) and 620 mg of 2,5-thiophenedicarboxylic acid (C₆H₄O₄S) are mixed and dissolved in a mixed solvent of 18 milliliters (mL) of N,N-dimethylformamide (C₃H₇NO) and 25 mL of ultrapure water to obtain a mixture. The mixture is ultrasonicated for 10 min to fully dissolve to obtain a ultrasonicated mixture. The ultrasonicated mixture is placed in a reaction autoclave and heated to 100 Celsius degrees (°C) for 5 hours (h) to obtain a heated mixture. After the reaction is completed, the heated mixture is washed with N,N-dimethylformamide three times to obtain a washed mixture. The washed mixture is soaked in acetone overnight to obtain a soaked mixture. The soaked mixture is dried in an oven at 60 °C for 24 h to obtain a metal-organic framework MIL-53 as an adsorption material.

In step 2, a mixed solution containing lead acetate at 100 mg/mL and MIL-53 at 15 mg/mL is prepared. The mixed solution is placed on a magnetic stirrer, heated to 90 °C, and stirred for 1 h to obtain a stirred solution. The stirred solution is placed in a 25 °C water bath to allow recrystallization of the lead acetate, thereby obtaining MIL-53 with adsorbed lead acetate (i.e., lead-loaded MIL-53).
(2) 40 mg of silk fibroin is added into 400 microliters (μL) of ultrapure water to stand for 10 min until fully dissolved to obtain a first mixed solution. 31.25 μL of polyethylene glycol diacrylate solution, 500 μL of mixture containing the MIL-53 with adsorbed lead acetate, 2.33 μL of [Ru(bpy)₃]Cl₂ solution at 6 mg/mL, 50 μL of potassium persulfate (KPS) solution at 60 mg/mL, and 1 μL of photoinitiator 1173 solution are added into the first mixed solution to obtain a second mixed solution. The second mixed solution is diluted to a final volume of 1 mL with ultrapure water and mixed thoroughly by oscillation to obtain a third mixed solution. Ruthenium (Ru) ions undergo redox reaction under light to excite KPS, and the excited-state KPS initiates cross-linking of the silk fibroin. The third mixed solution is simultaneously irradiated with 365 nm ultraviolet (UV) light and 405 nm blue light for 3 min to obtain an irradiated mixture. The irradiated mixture is placed in a −80 °C ultra-low temperature freezer for 3 h, followed by vacuum drying in a freeze dryer for 24 h to obtain the responsive aerogel.

### Embodiment 2

A responsive aerogel is prepared by the following steps.
(1) An integrated adsorption-response probe is synthetized.

In step 1, 1800 mg of aluminum nitrate (nonahydrate) and 620 mg of 2,5-thiophenedicarboxylic acid are mixed and dissolved in a mixed solvent of 18 mL of N,N-dimethylformamide and 25 mL of ultrapure water to obtain a mixture. The mixture is ultrasonicated for 10 min to fully dissolve to obtain a ultrasonicated mixture. The ultrasonicated mixture is placed in a reaction autoclave and heated to 100 °C for 5 h to obtain a heated mixture. After the reaction is completed, the heated mixture is washed with N,N-dimethylformamide three times to obtain a washed mixture. The washed mixture is soaked in acetone overnight to obtain a soaked mixture. The soaked mixture is dried in an oven at 60 °C for 24 h to obtain a metal-organic framework MIL-53 as an adsorption material.

In step 2, a mixed solution containing lead acetate at 50 mg/mL and MIL-53 at 6.5 mg/mL is prepared. The mixed solution is placed on a magnetic stirrer, heated to 90 °C, and stirred for 1 h to obtain a stirred solution. The stirred solution is placed in a 25 °C water bath to allow recrystallization of the lead acetate, thereby obtaining MIL-53 with adsorbed lead acetate.
(2) 20 mg of silk fibroin is added into 400 μL of ultrapure water to stand for 10 min until fully dissolved to obtain a first mixed solution. 15.6 μL of polyethylene glycol diacrylate solution, 500 μL of mixture containing the MIL-53 with adsorbed lead acetate, 2.33 μL of [Ru(bpy)₃]Cl₂ solution at 6 mg/mL, 50 μL of KPS solution at 60 mg/mL, and 1 μL of photoinitiator 1173 solution are added into the first mixed solution to obtain a second mixed solution. The second mixed solution is diluted to a final volume of 1 mL with ultrapure water and mixed thoroughly by oscillation to obtain a third mixed solution. The third mixed solution is simultaneously irradiated with 365 nm UV light and 405 nm blue light for 3 min to obtain an irradiated mixture. The irradiated mixture is placed in a −80 °C ultra-low temperature freezer for 3 h, followed by vacuum drying in a freeze dryer for 24 h to obtain the responsive aerogel.

### Embodiment 3

A responsive aerogel is prepared by the following steps.
(1) An integrated adsorption-response probe is synthetized.

In step 1, 1800 mg of aluminum nitrate (nonahydrate) and 620 mg of 2,5-thiophenedicarboxylic acid are mixed and dissolved in a mixed solvent of 18 mL of N,N-dimethylformamide and 25 mL of ultrapure water to obtain a mixture. The mixture is ultrasonicated for 10 min to fully dissolve to obtain a ultrasonicated mixture. The ultrasonicated mixture is placed in a reaction autoclave and heated to 100 °C for 5 h to obtain a heated mixture. After the reaction is completed, the heated mixture is washed with N,N-dimethylformamide three times to obtain a washed mixture. The washed mixture is soaked in acetone overnight to obtain a soaked mixture. The soaked mixture is dried in an oven at 60 °C for 24 h to obtain a metal-organic framework MIL-53 as an adsorption material.

In step 2, a mixed solution containing lead acetate at 400 mg/mL and MIL-53 at 30 mg/mL is prepared. The mixed solution is placed on a magnetic stirrer, heated to 90 °C, and stirred for 1 h to obtain a stirred solution. The stirred solution is placed in a 25 °C water bath to allow recrystallization of the lead acetate, thereby obtaining MIL-53 with adsorbed lead acetate.
(2) 80 mg of silk fibroin is added into 400 μL of ultrapure water to stand for 10 min until fully dissolved to obtain a first mixed solution. 125 μL of polyethylene glycol diacrylate solution, 500 μL of mixture containing the MIL-53 with adsorbed lead acetate, 2.33 μL of [Ru(bpy)₃]Cl₂ solution at 6 mg/mL, 50 μL of KPS solution at 60 mg/mL, and 1 μL of photoinitiator 1173 solution are added into the first mixed solution to obtain a second mixed solution. The second mixed solution is diluted to a final volume of 1 mL with ultrapure water and mixed thoroughly by oscillation to obtain a third mixed solution. The third mixed solution is simultaneously irradiated with 365 nm UV light and 405 nm blue light for 3 min to obtain an irradiated mixture. The irradiated mixture is placed in a −80 °C ultra-low temperature freezer for 3 h, followed by vacuum drying in a freeze dryer for 24 h to obtain the responsive aerogel.

In the preparation process of the responsive aerogels provided in the embodiments 1-3, the silk fibroin and the polyethylene glycol diacrylate undergo a photo-curing reaction under the action of a photo-crosslinking agent to form a double-network aerogel substrate. The double-network aerogel substrate, together with the solution containing the MIL-53 with adsorbed lead acetate, undergoes the photo-curing reaction under the action of the photo-crosslinking agent, resulting in the final responsive aerogel. The double-network aerogel substrate possesses a porous structure, which enhances gas transport. Additionally, the double-network aerogel substrate has water-absorbing properties, thereby imparting humidity interference resistance to the final prepared responsive aerogel.

Since the performance of the responsive aerogels provided in the embodiments 1-3 is substantially the same, only the embodiment 1 is taken as an example below to illustrate their performance and effects.

### 1. Synthesis and Characterization of the Double-Network Aerogel Substrate

In order to test the performance of the double-network aerogel substrate, the independently prepared substrate is described below.

### (1) Synthesis of the Double-Network Aerogel Substrate

40 mg of silk fibroin is added into 400 μL of ultrapure water to stand for 10 min until fully dissolved to obtain a first mixed solution. 31.25 μL of polyethylene glycol diacrylate solution, 2.33 μL of [Ru(bpy)₃]Cl₂ solution at 6 mg/mL, 50 μL of KPS solution at 60 mg/mL, and 1 μL of photoinitiator 1173 solution are added into the first mixed solution to obtain a second mixed solution. The second mixed solution is diluted to a final volume of 1 mL with ultrapure water and mixed thoroughly by oscillation to obtain a third mixed solution. The third mixed solution is simultaneously irradiated with 365 nm UV light and 405 nm blue light for 3 min to obtain an irradiated mixture. The irradiated mixture is placed in a −80 °C ultra-low temperature freezer for 3 h, followed by vacuum drying in a freeze dryer for 24 h to obtain the double-network aerogel substrate.

### (2) Characterization of the Double-Network Aerogel Substrate

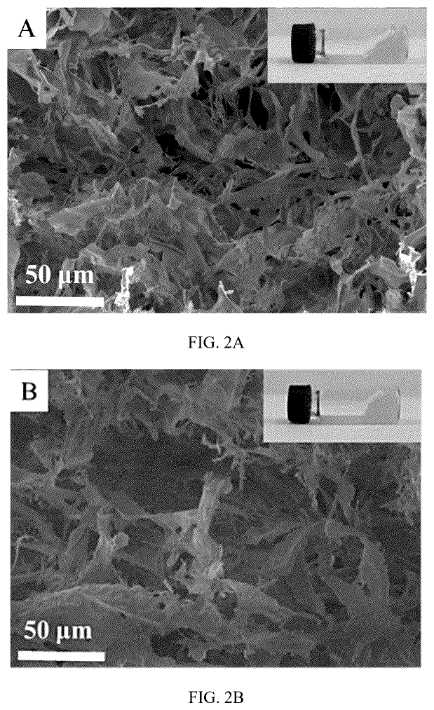

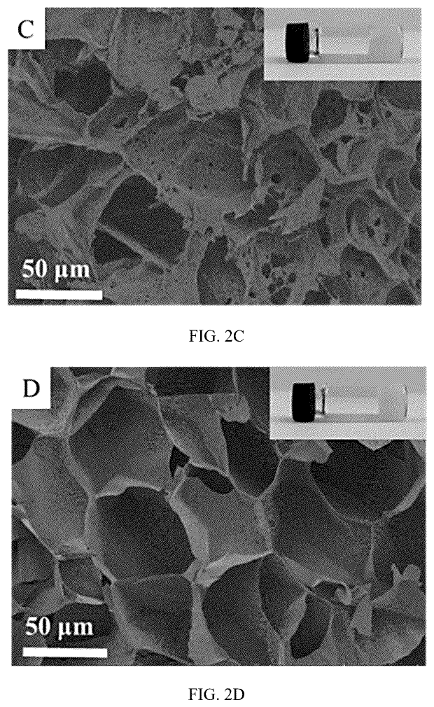

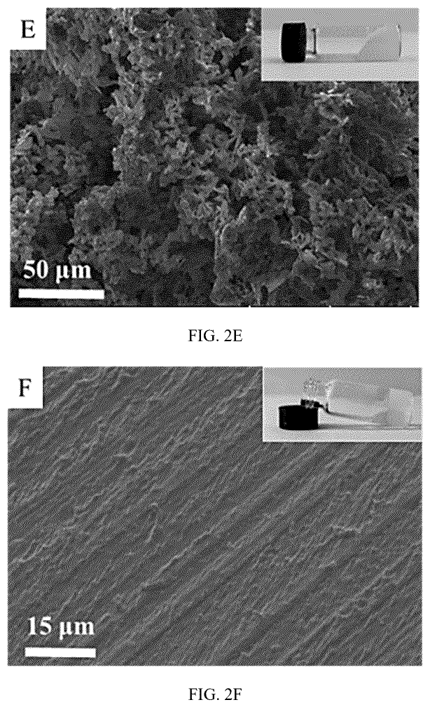

As shown in FIGS. 2A-2D, a silk fibroin precursor solution with a low-concentration (0.5 wt %) after cross-linking exhibits fibers of varying sizes. Increasing the concentration (1 wt %) forms more protein fibers, which begin to connect into sheets. At concentrations of 2 wt % and 4 wt %, a uniform and regular porous structure is formed by cross-linking. Furthermore, when the concentration of the cross-linker Ru(II) is determined to be 0.02 μM, an interconnected porous structure is formed. As shown in FIG. 2E, when the Ru concentration is too low, protein molecules only cross-link into interwoven strips macroscopically without a fixed shape. Since the polymerized polyethylene glycol diacrylate chains are too soft and cannot support the original porous structure after dehydration, the dried polyethylene glycol gel appears dense internally, as shown in FIG. 2F.

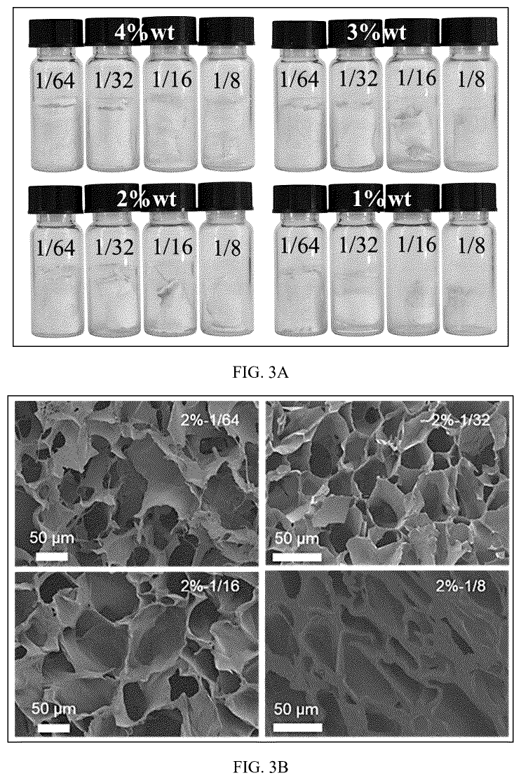

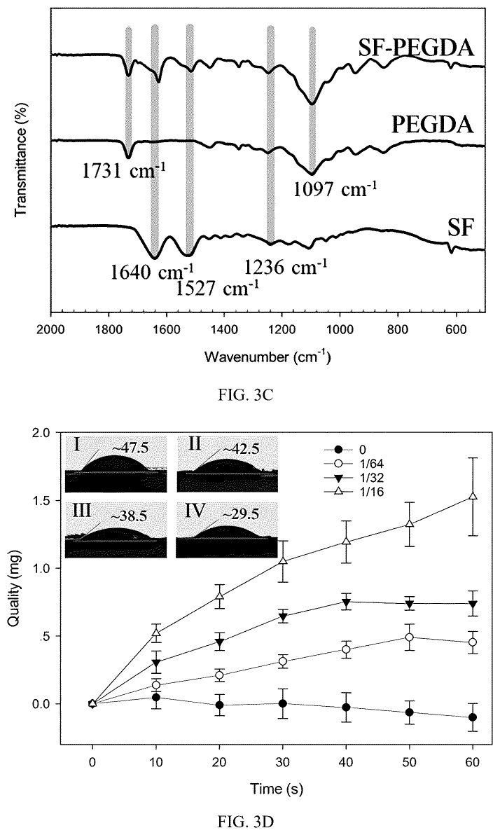

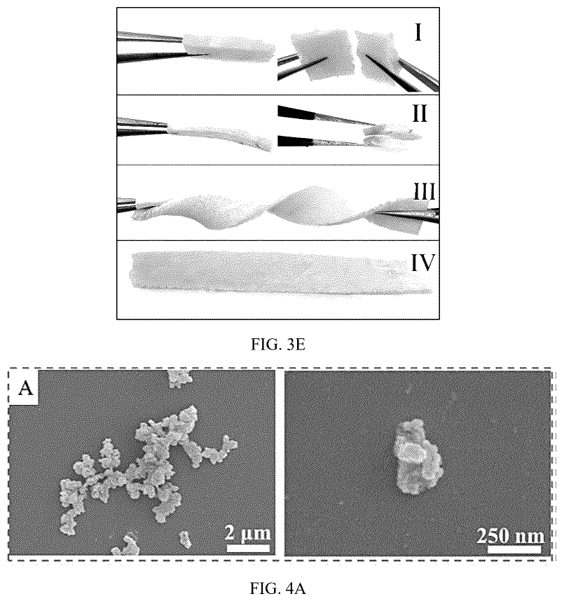

A double-network aerogel is prepared by mixing the silk fibroin and the polyethylene glycol diacrylate precursor solutions. Compared to pure silk fibroin aerogel, as shown in the SEM images in FIG. 3B, the silk fibroin-polyethylene glycol aerogel exhibits significantly reduced pore size and thicker, smoother pore walls. In the FTIR spectrum shown in FIG. 3C, the silk fibroin-polyethylene glycol aerogel contains characteristic peaks at 1640 reciprocal centimeters (cm⁻¹), 1527 cm⁻¹, and 1236 cm⁻¹, corresponding to amide I, amide II, and amide III, respectively. Among them, the amide II and the amide III are characteristic of silk fibroin folding and cross-linking. The characteristic peaks at 1097 cm⁻¹ and 1731 cm⁻¹ are attributed to stretching vibrations of C—O—C and C═O after polymerization of the polyethylene glycol diacrylate. Compared to spectra of the silk fibroin and the polyethylene glycol diacrylate, no new characteristic peaks appear in the silk fibroin-polyethylene glycol spectrum, which indicates that the cross-linking between the silk fibroin and the polyethylene glycol diacrylate is primarily through hydrogen bonding.

As shown in FIG. 3D, the pure silk fibroin aerogel has an extremely low water absorption capacity in this environment, resulting in no significant mass change. In contrast, the silk fibroin-polyethylene glycol aerogel exhibits significant mass increase, with both the water absorption rate and mass change increasing as the polyethylene glycol diacrylate content increases. This change in hydrophilicity can also be verified by water contact angle measurements. As the polyethylene glycol diacrylate content increases, the water contact angle decreases from 47.5° to 29.5°.

The physical images of the aerogel in FIG. 3E shows that although the silk fibroin network has good rigidity and can maintain its three-dimensional porous skeleton, it is prone to fracture and breakage under external force. After incorporating the soft and elastic polyethylene glycol diacrylate network, the silk fibroin-polyethylene glycol aerogel can be twisted 540° and bent 180° and then recover.

### 2. Characterization of the Integrated Adsorption-Response Probe (MIL-53 With Adsorbed Lead Acetate)

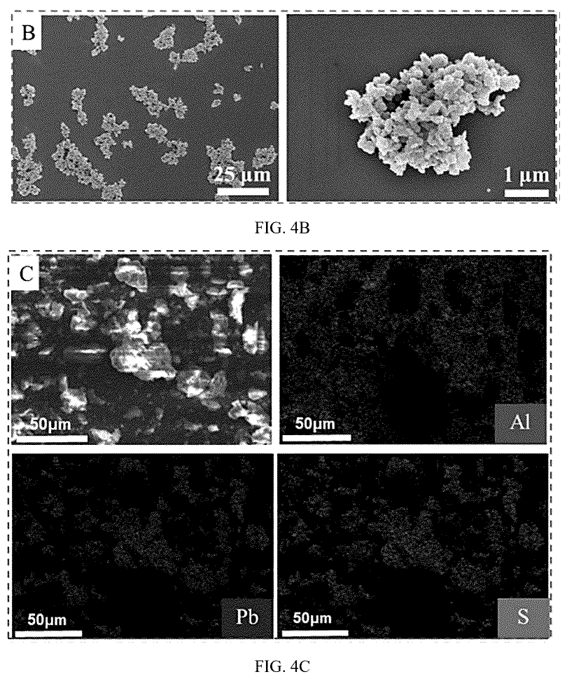

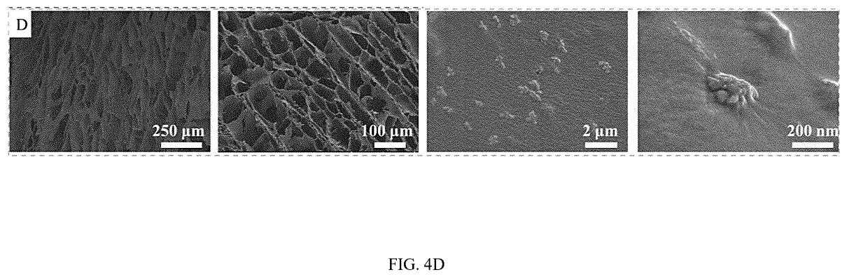

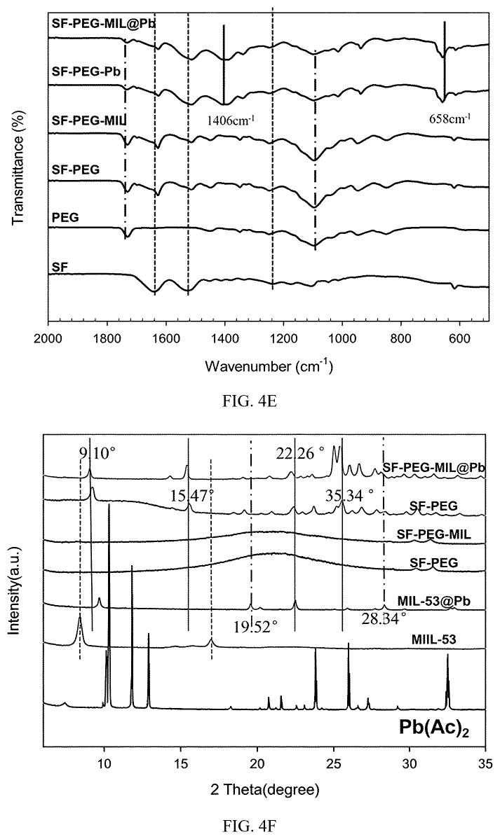

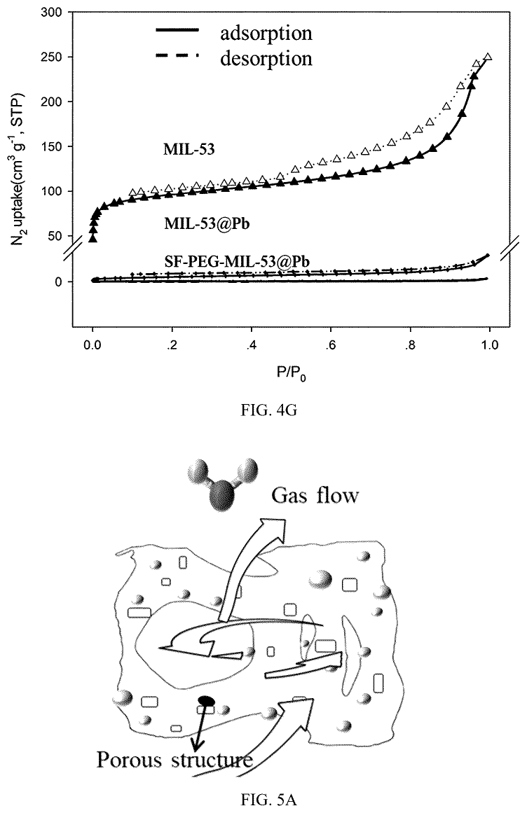

As shown in FIG. 4A, MIL-53 appears as irregularly shaped particles exhibiting an agglomerated state. FIG. 4B shows that after adsorbing lead acetate, the surface of MIL-53 appears more granular with a higher degree of agglomeration. FIG. 4C shows that in the EDS images of MIL-53@Pb, lead and aluminum elements are interwoven and distributed together, further indicating the formation of an interconnected composite material. MIL-53 and lead acetate possess good crystallinity, and their characteristic diffraction peaks in the XRD spectra are consistent with reported results. The XRD pattern of the MIL-53@Pb composite probe differs from those of MIL-53 and lead acetate, which shows new characteristic peaks at 9.79°, 19.52°, 20.12°, 22.42°, 25.25°, and 28.34°, indicating that the MIL-53@Pb composite exhibits a new crystal structure. The nitrogen (N₂) adsorption-desorption curves are tested to study the pore structure of the MIL-53@Pb composite. A specific surface area of MIL-53 is 360.6464 square meters per gram (m²/g), with an average pore size of 10.6408 nm. A specific surface area of MIL-53@Pb is 11.6112 m²/g, and the average pore size shows no significant change compared to MIL-53, approximately 10.5826 nm. This indicates that the adsorption of lead acetate by MIL-53 occurs only on the surface without pore blockage, which is beneficial for hydrogen sulfide transport.

### 3. Characterization of the Responsive Aerogel

FIG. 4D shows that the responsive aerogel maintains the three-dimensional porous structure of the double-network aerogel substrate, with the MIL-53@Pb probe uniformly distributed on the pore walls. FIG. 4F shows that the XRD pattern of the responsive aerogel retains the characteristic peaks of the silk fibroin-polyethylene glycol aerogel substrate (30.44°, and 21.42°), while also exhibiting characteristic peaks of the lead acetate (9.10°, 15.47°, 22.26°, and 35.34°) and MIL-53@Pb (19.52°, and 28.34°), indicating the successful loading of the MIL-53@Pb probe onto the silk fibroin-polyethylene glycol substrate. The FTIR spectrum in FIG. 4E shows two new characteristic peaks at 1406 cm⁻¹ and 658 cm⁻¹ in the responsive aerogel spectrum. These are attributed to the bending vibration of the hydroxide (—OH) group in lead acetate. The N₂ adsorption-desorption isotherm of the responsive aerogel in FIG. 4G exhibits a type II isotherm similar to that of MIL-53@Pb, whereas the initial silk fibroin-polyethylene glycol aerogel shows almost no N₂ adsorption. This fully demonstrates that the silk fibroin-polyethylene glycol aerogel serves as the primary microporous structure, while the uniformly distributed MIL-53@Pb provides the secondary nanoporous structure, thereby successfully constructing a hierarchical porous structure.

### 4. Detection of Hydrogen Sulfide by the Responsive Aerogel

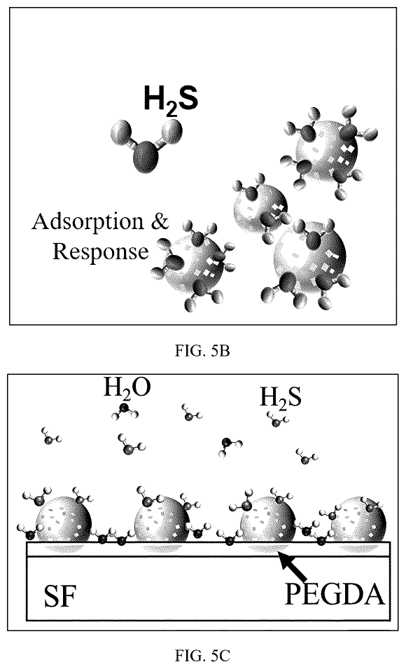

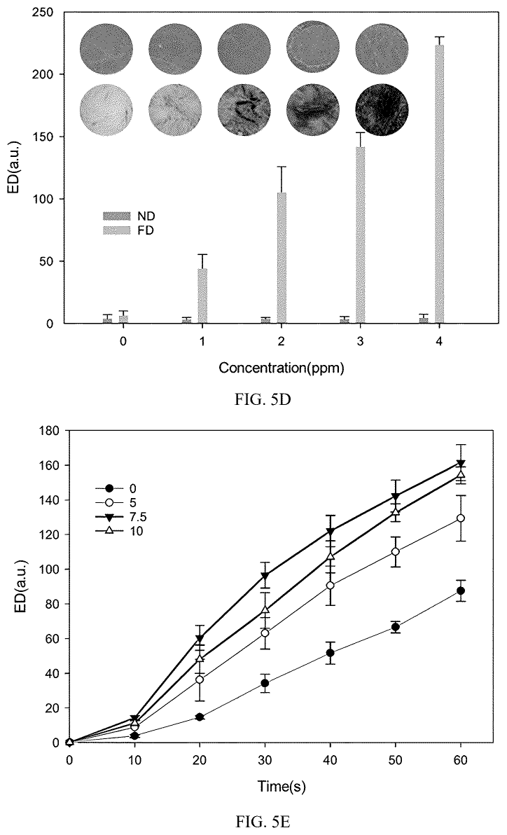

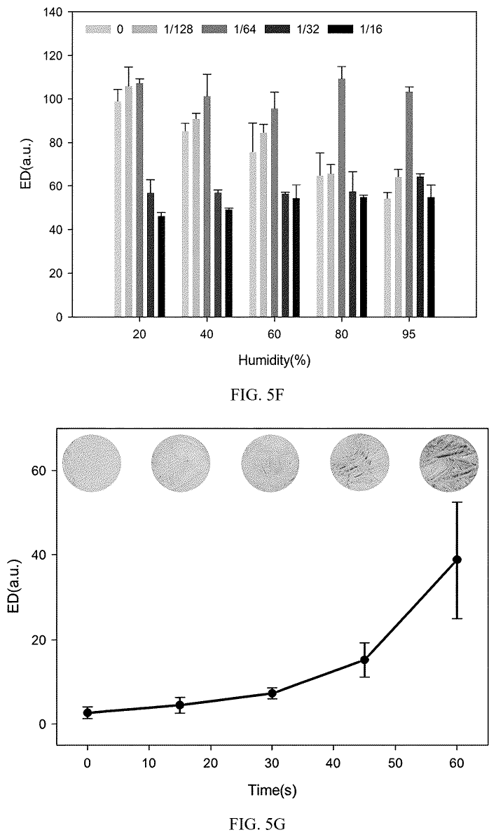

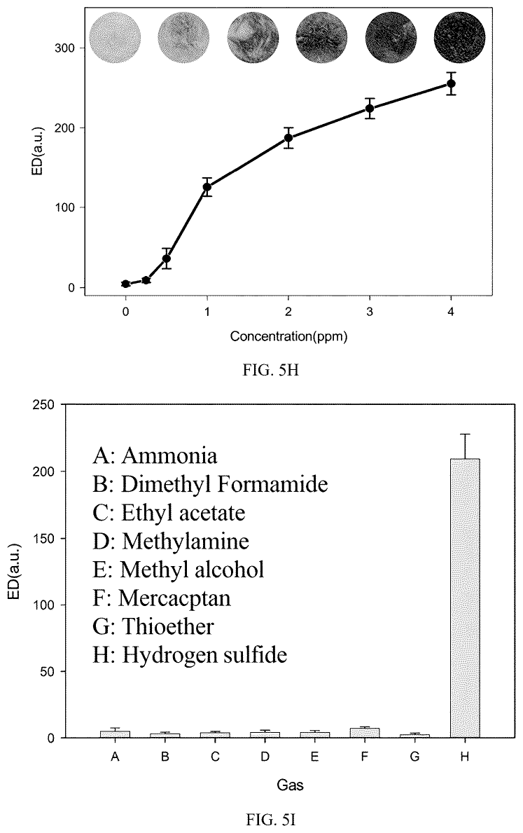

FIG. 5D shows that aerogels with a dense internal structure show no response even to high concentrations (4 parts per million, abbreviated as ppm) of hydrogen sulfide, while aerogels with a porous structure exhibit a good gradient response to different concentrations of hydrogen sulfide. This is because the porous structure after freeze-drying can effectively improve gas transport, thereby ensuring full contact between the gas and the response probe. In addition to its inherent structural advantages, constructing a hierarchical porous structure by adding materials with nanopores onto the surface of the porous substrate is an effective strategy to increase the capture rate of target gases, accelerate reactions with the probe, and thereby improve detection sensitivity. FIG. 5E shows that compared to aerogels without metal organic framework (MOF), aerogels with added MIL-53 show a substantial improvement in response throughout the entire reaction time period, with the highest response observed when the concentration of MIL-53 is 7.5 mg/mL. Therefore, the optimal concentration of MIL-53 is determined to be 7.5 mg/mL.

In addition to high sensitivity, the responsive aerogel exhibits good response stability under different humidity levels. FIG. 5F shows the response ED values of the responsive aerogels with different polyethylene glycol diacrylate contents to 1 ppm hydrogen sulfide at different humidity levels (20, 40, 60, 80, 90 relative humidity percentage, abbreviated as RH %). In the absence of polyethylene glycol diacrylate, the response ED value gradually decreases from 98.96 to 54.23 as humidity increases. This is because although increased humidity enhances molecular ionization, water adsorption by the substrate causes its own swelling, leading to increased transparency and consequently a decrease in the ED value. When the volume fraction of the polyethylene glycol diacrylate is greater than 1/64, the standard deviation of the response ED values under different humidity levels drops below 5, confirming that this method can reduce response variation and mitigate the influence of humidity. Furthermore, the response of the responsive aerogel containing 1/64 polyethylene glycol diacrylate to different concentrations of hydrogen sulfide is higher than that of the aerogel without polyethylene glycol diacrylate. For a hydrogen sulfide concentration of 1 ppm, the response ED value is increased by 3.39 times. This is because the water-absorbing substrate provides an excellent aqueous environment for the colorimetric reaction, thereby promoting the ionization of lead acetate and hydrogen sulfide molecules.

The responsive aerogel prepared by using a precursor solution with a concentration of the silk fibroin of 20 mg/mL, a volume fraction of the polyethylene glycol diacrylate of 1/32 (v/v), a concentration of the lead acetate of 50 mg/mL, and a concentration of the metal organic framework of 7.5 mg/mL is reacted with hydrogen sulfide with concentrations ranging from 0 ppm to 5 ppm. As shown in FIGS. 5G and 5H, the ED value of the responsive aerogel after reacting with 0.25 ppm hydrogen sulfide for 30 seconds (s) is 8.17. Converting to the Lab color space, ΔE=2.1, which is less than the human-eye-discernible threshold of 3. However, the concentration of 0.25 ppm can be detected through the calculation of the ED value, which is the detection limit of this sensor. The ED value is calculated according to the following formula.

A calculation formula of the Euclidean distance is expressed as follows:

ED=\sqrt{(R−R₀)²+(G−G₀)²+(B−B₀)²}
where R, G and B respectively represent the mean values of the three color channels of the responsive aerogel after the filtering, and R₀, G₀ and B₀ respectively represent the mean values of the three color channels of the responsive aerogel before the filtering.

A functional model relating the ED value to hydrogen sulfide concentration is established. The results show a cubic polynomial correlation between the ED value (Y) and the hydrogen sulfide concentration (x), with an R² of 0.991. The cubic polynomial correlation is expressed as follows:

10000 Y=−4+135 x−0.83595 x²+0.0036466 x³.

As shown in FIG. 5I, the responsive aerogel is exposed to various interfering molecules, including the inorganic gas ammonia; organic gases such as dimethylformamide, ethyl acetate, methylamine, and methanol; and other types of volatile sulfur compounds, including thiols and thioethers. The responsive aerogel exhibits an excellent response only to hydrogen sulfide. No color change is observed upon exposure to 5 ppm of other interfering gases, with ED values all less than 10, demonstrating excellent selectivity.

For those skilled in the art, it is evident that the disclosure is not limited to the details of the aforementioned embodiment 1. All modifications and equivalents that fall within the scope of the technical solution and claims of the disclosure are intended to be encompassed within the protection scope of the disclosure.

What is claimed is:

1. A responsive aerogel, wherein the responsive aerogel is prepared by the following steps:
mixing and dissolving a metal organic framework with lead acetate to obtain an integrated adsorption-response probe; and
mixing silk fibroin, polyethylene glycol diacrylate, and the integrated adsorption-response probe to obtain a mixed solution, and performing a photo-curing reaction on the mixed solution under an action of a photo-crosslinking agent to obtain the responsive aerogel.

2. The responsive aerogel as claimed in claim 1, wherein in the mixed solution, a concentration of the silk fibroin is in a range of 10 milligrams per milliliter (mg/mL) to 40 mg/mL, a volume fraction of the polyethylene glycol diacrylate is in a range of 1/64 to ⅛, a concentration of the lead acetate is in a range of 25 mg/mL to 200 mg/mL, and a concentration of the metal-organic framework is in a range of 3.25 mg/mL to 15 mg/mL.

3. The responsive aerogel as claimed in claim 1, wherein the photo-curing reaction is performed under simultaneous irradiation at 365 nanometers (nm) and 405 nm for at least 3 minutes (min).

4. The responsive aerogel as claimed in claim 1, wherein the photo-crosslinking agent is potassium persulfate, photoinitiator 1173, and tris(2,2′-bipyridine)dichlororuthenium(II) hexahydrate ([Ru(bpy)₃]Cl₂).

5. The responsive aerogel as claimed in claim 1, wherein the metal-organic framework is prepared by the following steps:
mixing aluminum salt, 2,5-thiophenedicarboxylic acid and N,N-dimethylformamide for reaction to obtain the metal-organic framework.

6. An application method of the responsive aerogel as claimed in claim 1, comprising:
detecting hydrogen sulfide gas by using the responsive aerogel.

7. A method for detecting hydrogen sulfide gas by using the responsive aerogel as claimed in claim 1, comprising:
filtering hydrogen sulfide gas to be detected by using the responsive aerogel, measuring a Euclidean distance of color change of the responsive aerogel under an action of the hydrogen sulfide gas, and calculating a concentration of the hydrogen sulfide gas by combining with a pre-calibrated curve.

8. The method as claimed in claim 7, wherein the measuring a Euclidean distance of color change of the responsive aerogel under an action of the hydrogen sulfide gas specifically comprises:
acquiring a color image of the responsive aerogel in a sealed environment with constant illumination;
extracting mean values of three color channels for a region of the responsive aerogel in the color image; and
calculating the Euclidean distance of the mean values of the three color channels of the responsive aerogel before and after reaction between the responsive aerogel and the hydrogen sulfide gas.

9. A sensor for detecting hydrogen sulfide gas, comprising the responsive aerogel as claimed in claim 1.
